(19) United States
(12) Patent Application Publication
(10) Pub. No.: US 2013/0341540 A1
(43) Pub. Date: Dec. 26, 2013

(54) Adjustable Damping Valve Arrangement

(71) Applicants: Thomas MANGER, Wasserlosen (DE); Achim Sauerbrey, Schweinfurt (DE)

(72) Inventors: Thomas MANGER, Wasserlosen (DE); Achim Sauerbrey, Schweinfurt (DE)

(73) Assignee: ZF Friedrichshafen AG

(21) Appl. No.: 13/926,124

(22) Filed: Jun. 25, 2013

(30) Foreign Application Priority Data
Jun. 25, 2012 (DE) 10 2012 210 685.5

(51) Int. Cl. F16F 9/46

(52) U.S. Cl. CPC F16F 9/46
USPC 251/30.01

(57) ABSTRACT

An adjustable damping valve arrangement comprises an actuator for controlling a main stage valve, wherein the main stage valve has a rigid main stage valve body which carries out an axial operating movement relative to a valve seat surface of the main stage valve, wherein a pre-opening valve having at least one spring element which in turn preloads a pre-opening valve body precedes the main stage valve body, wherein the main stage valve body is supported on the valve seat surface in the closed operating position by the pre-opening valve.

### BACKGROUND OF THE INVENTION

1. Field of the Invention

The invention is directed to an adjustable damping valve arrangement having an actuator for controlling a main stage value.

2. Description of the Related Art

An adjustable damping valve arrangement is known from DE 10 2008 041 735 B3 in which a main stage valve can be controlled by an auxiliary valve. The main stage valve comprises a rigid main stage valve body which seats on a valve seat ring. When a flow impinges on the main stage valve body via a through-hole, the main stage valve body lifts from the valve seat ring so that damping medium can flow through the damping valve arrangement.

When flow impinges on the damping valve arrangement from the opposite direction via at least one radial opening, the valve seat ring lifts together with the main stage valve body from a valve seat surface on the housing side.

Under certain conditions, impact noises which are caused at least in part by the valve seat ring occur in the damping valve arrangement. To reduce noise, a permanent throttle opening is provided, e.g., by stamping the end face of the main stage valve body or the valve seat ring of the valve ring. Because of the delicate structural component parts, it is difficult to stamp a permanent throttle opening in a precise manner without damaging the structural component part itself.

A damping valve arrangement forming the basis for the damping valve arrangement according to DE 10 2008 041 735 B3 is known from DE 37 19 113 C1. In addition to a rigid main stage valve body, DE 37 19 113 C1 also discloses in FIG. 3 a variant having a diaphragm as main stage valve body. The diaphragm is fixed at its outer circumference and forms a main stage valve in the middle diameter region with a valve seat surface. This construction involves some disadvantages which have prevented this design principle from being generally accepted. For example, the diaphragm must execute the entire lifting path proceeding from the valve seat surface. With a diaphragm formed by a plate spring, for example, the plate spring characteristic has a very great influence on the lift behavior. There is also no axial support of the diaphragm to limit the lifting path and thereby increase durability.

An adjustable damping valve arrangement with a main stage valve is also known from DE 198 22 448 A1. Hydraulically and with respect to the spatial arrangement parallel to the main stage valve, a constant throttle cross section (FIG. 3) is used which cooperates in turn with a supplemental valve.

It is an object of the present invention to provide a damping valve arrangement in which the problem of noise is minimized.

### SUMMARY OF THE INVENTION

This object is met according to the invention in that a pre-opening valve having at least one spring element which in turn preloads a pre-opening valve body precedes the main stage valve body, wherein the main stage valve body is supported on the valve seat surface in the closed operating position by the pre-opening valve.

The pre-opening valve achieves two important functional advantages simultaneously. On the one hand, there are no impact noises during a closing movement of the main stage valve due to the elastic bearing support by means of the spring element. Further, an improved damping force transition between the “main stage valve closed” operating position and the “main stage valve in opening movement” operating position is achieved by means of the pre-opening valve, and the damping valve arrangement can be constructed so as to be continuously adjustable.

In a further advantageous embodiment, the spring element and the pre-opening valve body are combined in at least one flexible disk. In principle, the at least one spring element and the pre-opening valve body can be produced and assembled as separate structural component parts. With respect to assembly, the use of flexible disks is appreciably simpler and cheaper.

According to an advantageous embodiment, the pre-opening valve is fastened to the main stage valve body. In principle, the pre-opening valve could also be stationary inside the damping valve arrangement. In this case, a first valve seat surface would have to be used for the pre-opening valve and a second valve seat surface would have to be used for the main stage valve. However, this would involve a substantial expenditure. By arranging the pre-opening valve at the main stage valve body, only one individual valve seat surface is used for both the main stage valve and the pre-opening valve.

The opening path of the pre-opening valve is limited by a supporting surface at the main stage valve body for a positive influence on the sturdiness of the pre-opening valve.

The supporting surface can be divided radially to form a clamping surface of the main stage valve body for the pre-opening valve body. Any inaccuracies in the shape of the main stage valve body do not influence the opening characteristic of the pre-opening valve.

A further possibility is to form the supporting surface and the clamping surface on different planes. The valve characteristic of the pre-opening valve can be adjusted exactly by means of a vertical and a radial offsetting of the two surfaces.

As a further step for influencing the valve characteristic, a permanently open flow cross section can be formed in the pre-opening valve body. A cutout, e.g., in a valve disk of the pre-opening valve, can be produced in a very precise manner without damaging other structural component parts of the valve.

Further, the valve seat surface for the main stage valve body can be formed at an axially movable valve seat ring which in turn seats on a valve seat surface on the housing side, wherein the valve seat surface on the housing side is constructed so as to be flexible. This construction is particularly useful when different pressure-impinged surfaces for different incident flow directions are provided for the opening movement of the main stage valve.

Here, again, there is the option that the housing-side valve seat surface is formed by a disk spring.

An expanded functionality can be achieved when the disk spring forms a pre-opening valve by means of an outlet channel.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described more fully referring to the following description of the drawings in which:

FIG. 1 is a cross-sectional view of a damping valve arrangement according to the invention;

FIG. 2 is a detailed view in the region of a valve seat ring; and

FIG. 3 is detailed view of a section of a pre-opening valve with a plurality of flexible disks.

### DETAILED DESCRIPTION OF THE PRESENTLY PREFERRED EMBODIMENTS

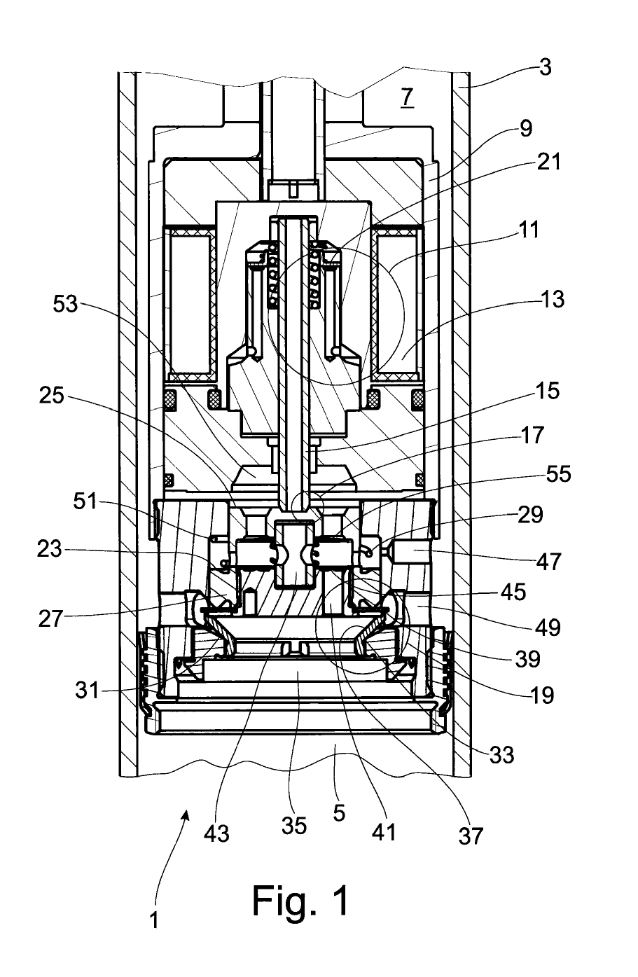

FIG. 1 shows a damping valve arrangement 1 for a vibration damper of any type of construction. The damping valve arrangement 1 can be arranged inside a cylinder 3 of the vibration damper between two working chambers 5; 7 as well as outside the cylinder 3 in a bypass line. An actuator 11 is arranged in a damping valve housing 9. In this example, the actuator 11 comprises a magnetic coil 13 which exerts an axial actuating force on an axially movable auxiliary valve body 15 of an auxiliary valve 17. The closing force can influence a main stage valve 19 by means of the auxiliary valve 17. The closing force is determined by the force of at least one valve spring 21, an actuating force of the actuator 11 opposing the valve spring force and a hydraulic closing force which is generated by the pressure on at least one pressure-impinged surface 23; 25 at a rigid main stage valve body 27.

The main stage valve body 27 is additionally preloaded by a main stage valve spring 29 on an axially movable valve seat ring 31, the valve seat ring 31 seating in turn on a valve seat surface 33 on the housing side. The valve seat ring 31 has a funnel-shaped enlargement 37 proceeding from a first incident flow opening 35 for a first incident flow direction of the damping medium, the end face of this funnel-shaped enlargement 37 forming a valve seat surface 39 for the main stage valve body 27.

The main stage valve body 27 has at least one inlet channel 41 leading from the first incident flow opening 35 to a control space 43 to make use of the hydraulic pressure inside the damping valve arrangement 1 for generating a closing force on the main stage valve body 27. A check valve 45 at the end of the inlet channel 41 determines the flow direction in direction of the control space. A second inlet channel 47 likewise leads to the control space 43 hydraulically parallel to at least one second incident flow opening 49 for a second incident flow direction of the damping valve arrangement 1. An outlet cross section 51 of the control space 43 to a rear space 53 is determined by the auxiliary valve body 15 and with the latter forms the auxiliary valve 17. A second check valve 55 connects the rear space 53 of the auxiliary valve 17 to the control space 43 in order to minimize the hydraulic resistance during this opening movement of the main stage valve 19 as the volume of the rear space 53 decreases. The check valve 45 can also be constructed as a damping valve in order to influence the opening speed of the main stage valve 19.

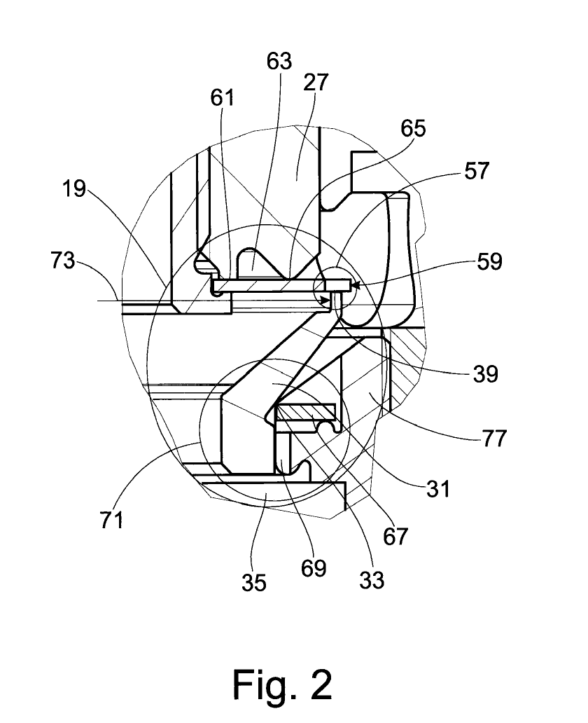

In addition to the auxiliary valve 17 and main stage valve 19, the damping valve arrangement 1 has a pre-opening valve 57 which has at least one spring element which in turn preloads a pre-opening valve body. It can be seen particularly in FIG. 2 that the spring element and the pre-opening valve body are combined in at least one flexible disk 59. The main stage valve body 27 is supported in the closed operating position of the main stage valve 19 on the valve seat surface 39 by the pre-opening valve 57. The valve seat surface 39 for the pre-opening valve 57 and the valve seat surface 39 for the main stage valve body 27 are identical with incident flow through the first incident flow opening 35 because the pre-opening valve 57, or the component of the auxiliary valve 57 moving in this incident flow, is fastened to the main stage valve body 27.

As can further be seen from FIG. 2, the main stage valve body 27 is formed of a plurality of parts. For the flexible disk 59, the main stage valve body 27 has a clamping surface 61 which is radially divided by an annular groove 63 to form a supporting surface 65. Further, it is also possible that the supporting surface 65 and the clamping surface 61 are formed on different planes so that, if necessary, the at least one flexible disk 59 is already shielded in the closed position of the pre-opening valve 57. The at least one flexible disk 59 can also have a permanently open flow cross section 66.

Optionally, the valve seat ring 31 can also seat on a flexible valve seat surface 33 on the housing side as is also shown in FIG. 2. For example, at least one flexible disk spring 67 is fixed to the housing ring 77. Additionally, the disk spring 67 with an outlet channel 69 can form a pre-opening valve 71 for a second incident flow direction via the at least one second incident flow opening 49 of the damping valve housing 9.

With incident flow in the main stage valve 19 proceeding from the first incident flow opening 35, the operating pressure is applied radially inside the valve seat surface 39 on the rigid inner region of the main stage valve body 27 and flexible disk. As a result of the funnel shape of the valve seat ring 31, a pressure-impinged surface 73 above a funnel input is greater than at the funnel output so that the operating pressure in the region of the first incident flow opening 35 provides for a fixating force which holds the valve seat ring 31 on the housing-side valve seat surface 33.

Starting from the first incident flow opening 35, the damping medium flows along the inlet channel 41 in the main stage valve body 27 into the control space 43 and through the auxiliary valve 17 into the rear space 53. The pressure on the first annular pressure-impinged surface 23 and on a rear end face, as further pressure-impinged surface 25, and the resulting force on the auxiliary valve body 15 caused by the valve spring force, actuator force and the force of the main stage valve spring result in a closing force on the main stage valve body 27.

When the main stage valve 19 is closed, i.e., the main stage valve body 27 seats on the valve seat surface 39 together with the flexible valve disk, the auxiliary valve 17 opens when there is incident flow. The opening behavior depends inter alia on the size of the permanently open flow cross section 66. In the absence of flow cross section 66, the pre-opening valve 57 opens a passage already at a lower pressure level, i.e., the at least one flexible disk 59 lifts at the edges from the valve seat surface 39. Depending on construction type, the pre-opening valve 57 does not open immediately to a larger flow cross section 66 but rather opens a flow cross section 66 by means of the elastic deformation before the main stage valve 19 lifts by correspondingly controlling the auxiliary valve 17. A softer transition from the closed position of the main stage valve 19 and an open operating position is achieved. The maximum open position of the flexible disk 59 is reached through the main stage valve body 27 itself, at which the flexible disk 59 can be supported axially.

By controlling the auxiliary valve 17 in a corresponding manner, the main stage valve 19 closes again. The flexible disk 59 of the pre-opening valve 57 then acts as a cushion to cushion the impact of the main stage valve body 27 on the valve seat surface 39 and accordingly at least minimizes an impact noise.

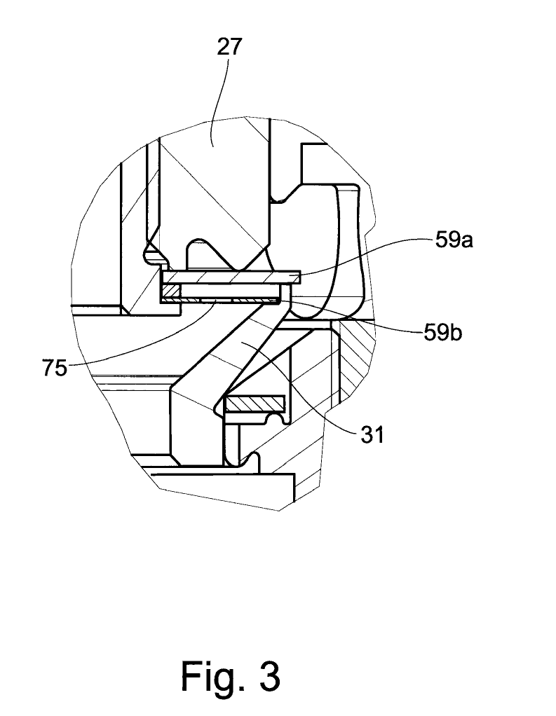

In case of a conflict of aims between the spring force characteristics of the flexible disk 59 with respect to the cushioning of the main stage valve body 27 and the opening behavior of the pre-opening valve 57, a plurality of disks 59 can be provided, for example, as is shown in FIG. 3. A first flexible disk 59b rests on the valve seat ring 31; this seating surface at the valve seat ring 31 need not have a sealing function. At least one pressure compensation opening 75 is formed in the first flexible disk 59 b so that the damping medium is present, virtually without throttling, at the second flexible disk 59a forming the pre-opening valve 57. This flexible disk 59a can have an appreciably greater spring rate than disk 59b. Of course, the spring rates of the two flexible disk 59a; 59b can also be selected so as to be exactly opposed, i.e., the first flexible disk 59b has a greater spring rate with respect to the cushioning function and the second flexible disk 59a has a smaller spring rate with respect to a small opening force for the pre-opening valve. In every case, the second flexible disk 59a can assume a supporting function for the first flexible disk 59b to limit shielding.

When the damping valve arrangement 1 is impinged via the radial second incident flow opening 49 (FIG. 1), the operating pressure is present at the underside of the valve seat ring 31 radially outside of the housing-side valve seat surface 33. A pilot flow acts hydraulically in parallel via the second inlet channel 47 in the control space 43. The auxiliary valve 17 in turn determines the pressure level at the annular pressure-impinged surface 23 and the rear side 25 of the main stage valve body 27. There is at least one connecting channel, not shown, between the rear space 53 of the auxiliary valve 17 and the first incident flow opening 35 so that the pressure level in the rear space 53 can deviate from the pressure level in the control space 43. The check valve 45 is closed in direction of the first inlet channel 41, as is the check valve 55 between the rear space 53 and the control space 43.

During an opening movement of the main stage valve 19, the valve seat ring 31 together with the main stage valve body 27 lifts from the housing-side valve seat surface 33. In this regard, the valve seat ring 31 is to be considered functionally as a component part of the main stage valve body 27.

If a closing position of the main stage valve 19 is predetermined via the auxiliary valve 17, the pre-opening valve 57 likewise acts in a cushioning manner at the main stage valve body 27 in the simplified variant according to FIG. 1 because the flexible disk 59 acts as a spring between the valve seat ring 31 and the main stage valve body 27. The closing movement is accordingly cushioned. Trials have shown that, by itself, the embodiment according to FIG. 1 solves the above-mentioned noise problem very well.

FIG. 2 additionally shows a variant in which the closing movement of the main stage valve 19, i.e., when the valve seat ring 31 again encounters the housing-side valve seat surface 33, is cushioned exactly at this location. For this purpose, the valve seat surface 33 on the housing side is formed flexibly in that the housing-side valve seat surface 33 is formed by a disk spring 67. The disk spring 67 is fixed to a ring of the housing 77. Starting from the radial second incident flow opening 49, an outlet channel 69 which opens into the first incident flow opening 35 is arranged downstream of the disk spring 67 in the housing ring 77. Accordingly, a pre-opening valve 57; 71 is also available in case of incident flow proceeding from the radial second incident flow opening 49. Of course, this disk spring 67 can also have a permanently open flow cross section 66.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. An adjustable damping valve arrangement comprising:
a main stage value (19) comprising a rigid main stage valve body (27) and a valve seat surface (39);
an actuator (11) for controlling said main stage valve (19), said rigid main stage valve body (27) carrying out an axial operating movement relative to said valve seat surface (39) of said main stage valve (19);
a pre-opening valve (57) having a pre-opening valve body preceding said main stage valve body (27); said pre-opening valve (57) having at least one spring element for preloading said pre-opening valve body, and wherein said main stage valve body (27) is supported on said valve seat surface (39) in the closed operating position by said pre-opening valve (57).

2. The adjustable damping valve arrangement according to claim 1, wherein said spring element and said pre-opening valve body are combined in at least one flexible disk (59; 67).

3. The adjustable damping valve arrangement according to claim 1, wherein said pre-opening valve (57) is fastened to said main stage valve body (27).

4. The adjustable damping valve arrangement according to claim 1, wherein said pre-opening valve has an opening path, and said main stage valve body has a supporting surface (65); said opening path of said pre-opening valve (57) being limited by said supporting surface (65) at said main stage valve body (27).

5. The adjustable damping valve arrangement according to claim 4, wherein said supporting surface (65) is divided radially to forma clamping surface (61) of said main stage valve body (27) for said pre-opening valve body.

6. The adjustable damping valve arrangement according to claim 5, wherein said supporting surface (65) and said clamping surface (61) are formed on different planes.

7. The adjustable damping valve arrangement according to claim 1, wherein said pre-opening valve body comprises a permanently open flow cross section (66).

8. The adjustable damping valve arrangement according to claim 1, additionally comprising an axially movable valve seat (31) and a housing side valve seat surface (33); wherein said valve seat surface (39) for said main stage valve body (27) is formed at said axially movable valve seat ring (31) which seats on said housing-side valve seat surface (33), and wherein said housing-side valve seat surface (33) is constructed so as to be flexible.

9. The adjustable damping valve arrangement according to claim 8, additionally comprising a disk spring (67) and wherein said housing-side valve seat surface (33) is formed by said disk spring (67).

10. The adjustable damping valve arrangement according to claim 9, additionally comprising an outlet channel (69) and wherein said disk spring (67) forms a second pre-opening valve (71) in cooperation with said outlet channel (69).
